(19) United States
(12) Patent Application Publication
(10) Pub. No.: US 2026/0054469 A1
(43) Pub. Date: Feb. 26, 2026

(54) COLORED STAINLESS STEEL BONDED SHEET FOR AUTOMOBILE DOOR MOLDING MANUFACTURED BY BONDING DIFFERENT TYPES OF STAINLESS STEEL AND MANUFACTURING METHOD THEREOF

(71) Applicants: DSP Co., Ltd., Gimhae-si (KR); DSP INNOVATION Co., Ltd., Ansan-si (KR)

(72) Inventors: Jin Hyung KIM, Seoul (KR); Ji Hoon KIM, Seoul (KR)

(73) Assignees: DSP Co., Ltd., Gimhae-si (KR); DSP INNOVATION Co., Ltd., Ansan-si (KR)

(21) Appl. No.: 19/260,653

(22) Filed: Jul. 7, 2025

(30) Foreign Application Priority Data
Aug. 22, 2024 (KR) 10-2024-0112497

(51) Int. Cl. B32B 15/01; B32B 7/12; B32B 37/12; B32B 38/14

(52) U.S. Cl. CPC B32B 15/011; B32B 7/12; B32B 37/1284; B32B 38/14; B32B 2250/02; B32B 2307/4023; B32B 2307/7376; B32B 2605/00

(57) ABSTRACT

A colored stainless steel bonded sheet for automobile door molding according to the present disclosure includes: a surface material made of a 300 series stainless steel sheet manufactured to a preset thickness; a base material made of a 400 series stainless steel sheet that is attached to a back surface of the surface material in a flat shape and has magnetism; and an adhesive layer positioned between the surface material and the base material to bond the surface material and the base material to each other, wherein the surface material is formed by coating with a preset color through surface treatment, and the surface material has a relatively greater elongation than the base material.

### CROSS-REFERENCE TO RELATED APPLICATION

This application claims the benefit of priority under 35 U.S.C. § 119 (a) to Korean Patent Application No. 10-2024-0112497 filed on Aug. 22, 2024, the entire contents of which are incorporated herein by reference.

### BACKGROUND

### (a) Technical Field

The present disclosure relates to a colored stainless steel bonded sheet for automobile door molding and a manufacturing method thereof, and more particularly, to a colored stainless steel bonded sheet for automobile door molding manufactured by bonding different types of stainless steel having excellent corrosion resistance and processability by roll bonding, and a manufacturing method thereof.

### (b) Background Art

In general, stainless steel automobile door moldings are manufactured into door frames, door belts, quarter glasses, etc. by slitting stainless steel materials to specifications, and forming, bending, and pressing the stainless steel materials. Such finishing materials are intended to utilize unique physical properties of the materials, and as a part directly exposed to people's eyes, have a great influence on durability, corrosion resistance, glossiness, and aesthetics of color.

In addition, recently, in the case of the automobile door molding, glossy products with mirror-processed stainless steel surfaces, semi-glossy products with embossing, and color products with various coating processes are applied.

Stainless steel has various series depending on the manufacturing process, but here, austenite series (hereinafter referred to as 300 series stainless steel) with high chromium and nickel content and non-magnetism, and ferrite series (hereinafter referred to as 400 series stainless steel) with high chromium content and magnetism are mainly used.

Specifically, 300 series stainless steel has excellent corrosion resistance and processability, but there is a problem that it should go through a separate mirror process for surface gloss, and there is an inconvenience that magnetism may not be used when bonding door frames, door belts, PVC, TPC, etc., which are post-processing, or when injecting quarter glass inserts.

Since 400 series stainless steel may obtain the desired surface gloss by adding a skin pass process, and has magnetism, it has an advantage in post-processing, but it has low tensile strength and elongation, so it is weak to processing shock, and thus there is a problem that cracks occur during forming or bending.

In addition, 400 series stainless steel has poor corrosion resistance, so there are problems such as surface discoloration. Therefore, a method for solving these problems is required.

### SUMMARY OF THE DISCLOSURE

The present disclosure is devised to solve the problems of the above-described conventional technology, and has an object to provide a stainless steel bonded sheet for automobile door molding capable of securing corrosion resistance and processability and having magnetism by utilizing the advantages of both 300 series and 400 series stainless steels by bonding the 300 series stainless steel, which has relatively high tensile strength and elongation, as a surface material to an upper surface of a base material made of the preset 400 series stainless steel, and also increasing productivity during post-processing.

The problems of the present disclosure are not limited to the above-described problems, and other problems that are not described may be obviously understood by those skilled in the art from the following description.

To achieve the above object, a colored stainless steel bonded sheet for automobile door molding of the subject disclosure includes: a surface material made of a 300 series stainless steel sheet manufactured to a preset thickness; a base material made of a 400 series stainless steel sheet that is attached to a back surface of the surface material in a flat shape and has magnetism; and an adhesive layer positioned between the surface material and the base material to bond the surface material and the base material to each other, wherein the surface material is formed by coating with a preset color through surface treatment, and the surface material has a relatively greater elongation than the base material.

In addition, the surface material may expand when the base material is formed or bent toward inwardly, and maintain its surface condition without damage such as crack occurrence.

In addition, the surface material may be wound in a roll type during the surface treatment process.

In addition, the adhesive may be applied to at least one surface of the base material or the surface material or may be attached in a film form.

In addition, the surface material may have an elongation of approximately 50% or more and may be made of a material that is relatively more resistant to processing shock than the base material.

In addition, the surface material may be made of one of the stainless steel grades STS304, STS304L, STS304J1, STS316, or STS316L, and the base material may be made of one of the stainless steel grades STS409, STS411, STS430, STS436, or STS441.

In addition, the surface material may be formed to have a thickness of 0.1 mm to 0.3 mm, and the base material may be formed to have a thickness of 0.3 mm to 0.7 mm.

Meanwhile, to solve the above-described the problem, a manufacturing method of a stainless steel bonded sheet for automobile door molding includes the steps of: (a) manufacturing a base material with a 400 series stainless steel sheet, (b) preparing a surface material with a 300 series stainless steel sheet, (c) forming an adhesive layer by applying an adhesive to either a back surface of the surface material or an upper surface of the base material, (d) positioning the adhesive layer between the surface material and the base material and bonding the surface material and the base material to each other to manufacture the bonded sheet, and (e) processing the bonded sheet into a preset size and shape, wherein, in the step (b), a coloring process for controlling the color of the surface material is performed.

In addition, the bonded sheet bonded in the step (d) may have a bonding force of 200N or more.

In addition, the surface material may be performed by any one of a dry coating method using a vacuum deposition process, a wet coating method using wet coating on the surface, or a method of performing dry coating using vacuum deposition and then performing wet coating.

The colored stainless steel bonded sheet for automobile door molding and the manufacturing method thereof of the present disclosure for solving the above-described problem, by manufacturing bonded sheet by bonding the base material made of the 400 series stainless steel sheet having magnetism and the surface material made of the 300 series stainless steel sheet having non-magnetism, it is possible to prevent cracks from occurring on the processed surface through the characteristics of the high tensile strength and elongation of the surface material during the forming, bending, and press processing of the automobile door molding, and simply perform the manufacturing process of the molding through the base material having magnetism.

The effects of the present disclosure are not limited to the above-described effects, and other effects that are not described may be obviously understood by those skilled in the art from the claims.

### BRIEF DESCRIPTION OF DRAWINGS

FIG. 1 is a diagram illustrating a structure of a colored stainless steel bonded sheet for automobile door molding according to an embodiment of the present disclosure;

FIG. 2 is a diagram illustrating a state in which a surface material and a base material of the colored stainless steel bonded sheet for automobile door molding according to an embodiment of the present disclosure are bonded with an adhesive;

FIG. 3 is a diagram illustrating a state in which a 300 series stainless steel sheet is bent in the colored stainless steel bonded sheet for automobile door molding according to an embodiment of the present disclosure;

FIG. 4 is a diagram illustrating a state in which a 400 series stainless steel sheet is bent in the colored stainless steel bonded sheet for automobile door molding according to an embodiment of the present disclosure;

FIG. 5 is a diagram illustrating a difference between a product made of the colored stainless steel bonded sheet for automobile door molding according to an embodiment of the present disclosure and a product made of the conventional 400 series stainless steel single sheet by bending each of the products;

FIG. 6 is a diagram illustrating a detailed state in which the colored stainless steel bonded sheet for automobile door molding according to an embodiment of the present disclosure is deformed during forming or bending;

FIG. 7 is a diagram illustrating the results of an adhesive strength test of a bonded sheet according to an embodiment of the present disclosure;

FIG. 8 is a diagram illustrating the entire manufacturing process of the colored stainless steel bonded sheet for automobile door molding according to an embodiment of the present disclosure in sequence;

FIG. 9 is a diagram illustrating a detailed process of manufacturing a surface material in the manufacturing process of FIG. 8; and

FIG. 10 is a diagram schematically illustrating a device for manufacturing a colored stainless steel bonded sheet for automobile door molding of FIG. 9.

### DETAILED DESCRIPTION

In this specification, when a component (or region, layer, section, etc.) is referred to as “being on”, “connected to”, or “coupled to” another component, it means that the component may be directly disposed/connected/coupled to the other component, or a third component may be disposed therebetween.

Identical drawing numbers refer to identical components. Also, in the drawings, the thickness, ratio, and dimension of the components are exaggerated for the purpose of effectively explaining the technical contents.

The terms “and/or” includes all combinations of one or more that the associated components can define.

The terms ‘first’, ‘second’, etc. may be used to describe various components, but the components are not to be construed as being limited to the terms. The terms are used only to differentiate one component from other components. For example, the first component may be named the second component and the second component may also be similarly named the first component, without departing from the scope of the present disclosure. Singular expressions include plural expressions unless the context clearly indicates otherwise.

Additionally, the terms such as “below,” “lower,” “above,” and “upper” are used to describe the relationships between components depicted in the drawings. These terms are relative concepts and are described based on the directions indicated in the drawings.

Unless defined otherwise, all terms (including technical and scientific terms) used in this specification have the same meaning as generally understood by those skilled in the art to which the present disclosure pertains. In addition, the terms defined in commonly used dictionaries should be interpreted as having a meaning consistent with their meaning in the context of the relevant technology, and are explicitly defined herein, unless they would be interpreted in an idealized or overly formal sense.

It should be understood that term “include” or “have” specifies the presence of features, numerals, steps, operations, components, parts described in the specification, or combinations thereof, but do not preclude the presence or addition of one or more other features, numerals, steps, operations, components, parts, or combinations thereof.

A sheet for automobile door molding is composed of a single stainless steel sheet of 0.4 to 0.7T that may be processed in a desired shape by surface treatment, and is usually made of 400 series stainless steel, which is made of ferrite series.

The sheet for the automobile door molding using the 400 series stainless steel has the advantage of increasing gloss by adding a separate skin pass process after cold rolling, but due to low tensile strength and elongation, there is a problem with harsh bending due to fine cracks on the processed surface during forming and bending processing required for the manufacturing process of the automobile door molding. In addition, there are many problems such as surface discoloration due to low corrosion resistance. Therefore, in order to solve these problems, a bonded sheet for automobile door molding according to the present disclosure may produce a bonded sheet that utilizes the advantages of two steel grades by bonding stainless steel sheets having different characteristics.

Hereinafter, the embodiments of the present disclosure will be described in detail with reference to the accompanying drawings.

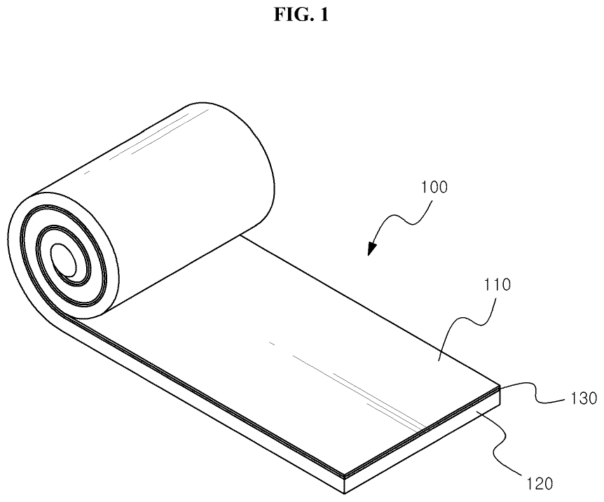

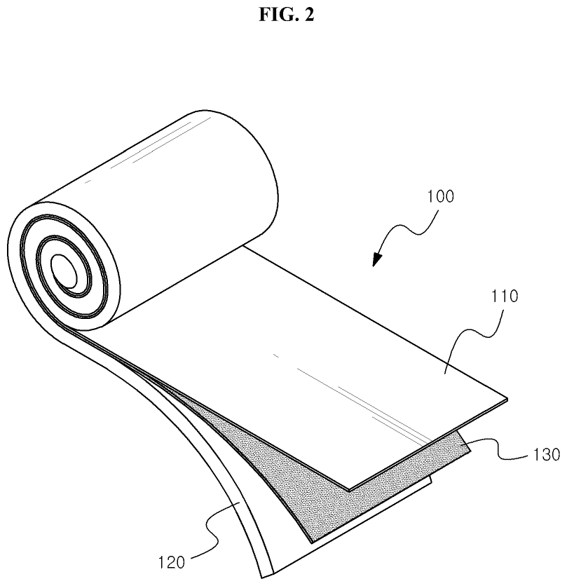

FIG. 1 is a diagram illustrating a structure of a colored stainless steel bonded sheet 100 for automobile door molding according to an embodiment of the present disclosure, and FIG. 2 is a diagram illustrating a state in which a surface material 110 and a base material 120 of the colored stainless steel bonded sheet 100 for automobile door molding according to an embodiment of the present disclosure are bonded with an adhesive.

As illustrated, the colored stainless steel bonded sheet 100 for automobile door molding according to an embodiment of the present disclosure includes the surface material 110, the base material 120, and an adhesive layer 130.

The surface material 110 is formed to have a preset thickness and area, and is made of a stainless steel sheet having non-magnetism. Specifically, the surface material 110 is made of 300 series stainless steel, which is an austenite series, and has a certain level or higher of elongation, and is a material having relatively stronger corrosion resistance than the base material 120 described below.

In this case, the surface material 110 is formed in a thin plate shape that is bonded to the base material 120 described later, and here, the surface treatment may be performed in a state of being coated with a preset color.

Specifically, the surface material 110 may additionally undergo a separate coloring process before bonding to the base material 120, and the coloring process may be performed using any one of a dry coating method using a vacuum deposition process, a wet coating method of a wet type, or a method of performing a wet coating after a dry coating, and accordingly, the surface material 110 is bonded to the base material 120 described later in a colored state.

The base material 120 is attached to a back surface of the surface material 110 and is made of a stainless steel sheet having magnetism as a material having relatively lower corrosion resistance or elongation than the surface material 110.

Specifically, the base material 120 is made of the 400 series stainless steel, which is ferrite series having magnetism, unlike the surface material 110, and is formed relatively thicker than the surface material 110.

That is, the surface material 110 is bonded based on the base material 120 to form a thin surface, forming the stainless steel bonded sheet 100 for automobile door molding.

Meanwhile, the adhesive layer 130 is positioned between the surface material 110 and the base material 120, and serves to bond the base material 120 to the surface material 110.

In this embodiment, the adhesive layer 130 may be directly applied to one surface of the base material 120 or the surface material 110 or attached in a film form to adhere the base material 120 and the surface material 100 to each other, and the base material 120 and the surface material 110 may be stably bonded by pressure and heat while being stacked.

Usually, in the case of the surface material 110, peeling occurs after a certain period of time when bonded with a conventional adhesive, and accordingly, there is a problem that it is difficult to maintain stable bonding.

However, in the present disclosure, the adhesive layer 130 uses an adhesive having a bonding force of 200N or more in a peel test, so that problems such as peeling during forming or bending may be suppressed, and additionally, it is desirable to produce the adhesive layer 130 to maintain an adhesive force of 300N or higher so that the adhesive layer 130 may withstand more severe processing such as reverse bending.

The overall process of bonding the surface material 110 and the base material 120 by the adhesive layer 130 will be described later.

The bonded sheet 100 for automobile door molding according to the present disclosure configured in this way is further processed to change its shape in the bonded state as described above, and may be stably processed by folding the surface material into a shape forming an outer surface.

In particular, in the stainless steel bonded sheet 100 for automobile door molding according to the present disclosure, the surface material 110 has characteristics of relatively greater elongation than the base material 120, and expands together when folding in a direction toward the base material 120 so that the surface material 110 may maintain the surface condition without being damaged.

The bonded sheet of the present disclosure configured in this way is formed in a state in which the base material 120 and the surface material 110 are bonded, unlike a sheet made of a single material of the 400 series stainless steel, which is a form mainly used in the past, and thus may have both the characteristics of the 300 series stainless steel and the 400 series stainless steel.

In particular, the bonded sheet 100 according to the present disclosure is configured such that the base material 120 is made of the 400 series stainless steel sheet, thereby maintaining the characteristics of a single 400 series stainless steel sheet used in the past, while the surface material 110 is made of the 300 series stainless steel sheet, thereby having relatively high elongation and tensile strength. That is, the present disclosure is configured to have both the characteristics of the 300 series stainless steel and the characteristics of the 400 series stainless steel.

As described above, the bonded sheet according to the present disclosure is not simply made of one type of sheet, but is formed by bonding the 300 series stainless steel sheet and the 400 series stainless steel sheet to form a single sheet, so the bonded sheet has a relatively low processing cost compared to the 400 series stainless steel sheet for automobiles that has undergone multiple skin pass processes used in the past, and has the advantage of being able to be processed stably due to high elongation and tensile strength when processed in a desired shape, and excellent corrosion resistance.

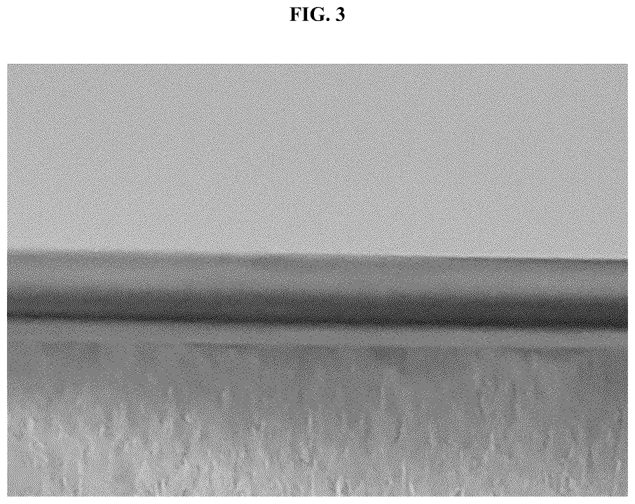

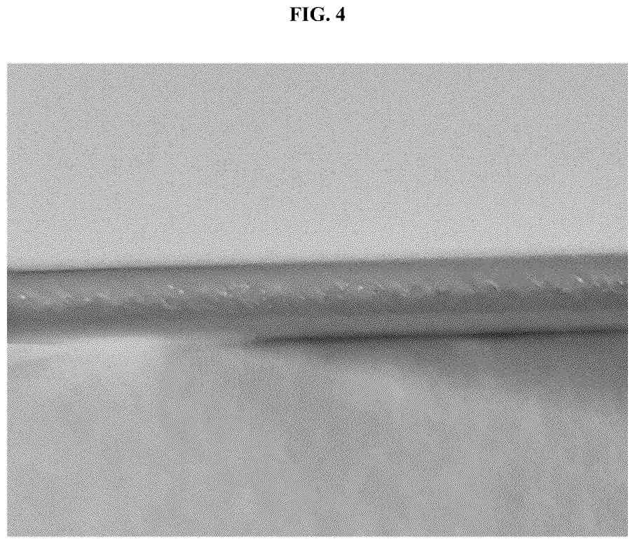

Next, the characteristics of the 300 series stainless steel sheet and the 400 series stainless steel sheet according to the present disclosure will be independently described with reference to FIGS. 3 and 4.

FIG. 3 is a diagram illustrating a state in which a 300 series stainless steel sheet is bent in a colored stainless steel bonded sheet 100 for automobile door molding according to an embodiment of the present disclosure, and FIG. 4 is a diagram illustrating a state in which a 400 series stainless steel sheet is bent in a colored stainless steel bonded sheet 100 for automobile door molding according to an embodiment of the present disclosure.

First, looking at FIG. 3, the 300 series stainless steel sheet is bent, which corresponds to the surface material 110 in the present disclosure.

The surface material 110 has an elongation of approximately 50%, has relatively higher elongation and tensile strength than the base material 120, and has a characteristic of being strong against processing shock. In particular, the 300 series stainless steel has strong corrosion resistance, so it shows a relatively strong appearance against damage or corrosion from the outside, and is made of a material suitable for an exterior material.

Accordingly, as shown in the drawing, even when the 300 stainless steel sheet is processed by zero bending and bent in a completely folded form, the 300 stainless steel sheet expands at the corresponding position to maintain the surface condition and is not damaged.

The surface material 110 is preferably made of one of the steel grades of STS304, STS30L, STS304J1, or STS316L, and in this embodiment, STS304L, which is relatively inexpensive and contains Ti (titanium), is used.

In addition, the surface material 110 may be formed to have a thickness of 0.1 mm to 0.3 mm. This is to have a thin thickness compared to the base material 120 described later, so as to minimize the manufacturing cost of the colored stainless steel bonded sheet 100 for automobile door molding according to the present disclosure, and to position the surface material 110 at a position where deformation occurs a lot during subsequent processing.

In addition, a hairline may be processed on the surface of the surface material 110, or various surface finishing processes such as vibration, bead blast, and embo may be performed.

In this way, the surface material 110 shown in FIG. 3 is relatively easy to process due to the characteristics of the material, and the surface may be processed later.

Meanwhile, looking at FIG. 4, the 400 series stainless steel sheet is in a bent state, and corresponds to the base material 120 in the present disclosure.

The base material 120 is attached to the back surface of the surface material 110 and has an elongation of about 20 to 30%, which is relatively lower than the surface material 110, and has a weak characteristic to processing shock, but has magnetism and may be inexpensive. In particular, in the case of the 400 series stainless steel, since the elongation is low, it is advantageous to form a frame inside rather than being disposed on the surface.

However, since the 400 series stainless steel sheet is a material with magnetism, the 400 series stainless steel sheet has an advantage in positioning using magnetism during additional post-processing, and has an advantage in having a certain level or higher of strength, but has a disadvantage of being susceptible to processing impact due to its low elongation.

When the base material 120 is deformed to a certain level or higher, it is damaged due to low elongation, and in particular, when the base material 120 is processed with zero bending as shown and bent in a completely folded form, cracks occur on the surface.

The base material 120 is preferably made of one of the steel grades STS409, STS430, STS436, or STS441, and in this embodiment, STS409 is used.

In addition, the base material 120 may be formed to have a thickness of 0.3 mm to 0.7 mm. This is to have a thicker thickness than the surface material 110, and to maintain a certain level of rigidity while allowing the surface material 110 to be positioned at a position where severe processing occurs a lot during the post-processing of the bonded sheet 100.

In this way, the 300 series stainless steel sheet and the 400 series stainless steel sheet each have different characteristics, and by bonding the 300 series stainless steel sheet and the 400 series stainless steel sheet as the surface material 110 and the base material 120, the bonded sheet 100 of the present disclosure is configured.

As described above, in this embodiment, the surface material 110 may be STS304L, and the base material 120 may be STS409, which may be selected by considering the yield strength, the tensile strength, and the elongation based on the table derived through the Posco Mill Test Certificate as illustrated in Table 1 below.

TABLE 1

| | Austenite series | | | Ferrite series | | |
|---|---|---|---|---|---|---|
| Division | 304 | 304L | 316L | 409 | 430 | 430J1L |
| Yield Strength | 298 | 287 | 272 | 243 | 326 | 319 |
| Tensile Strength | 668 | 628 | 578 | 394 | 504 | 463 |
| Elongation | 52 | 52 | 58 | 37 | 27 | 34 |

Based on the above-described Table 1, the surface material 110 and the base material 120 according to the present disclosure may be made of stainless steel having different thicknesses and characteristics.

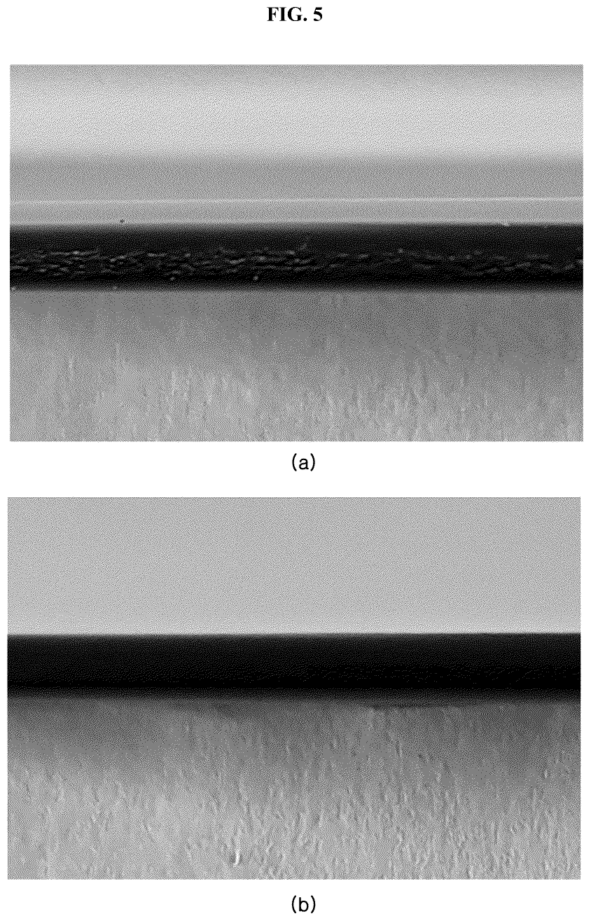

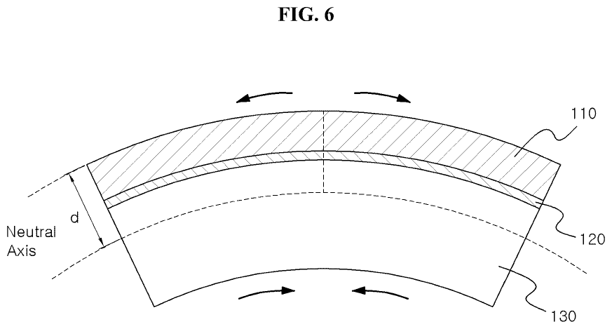

Next, referring to FIGS. 5 and 6, the bonded sheet in which the base material 120 and the surface material 110 are bonded in the colored stainless steel bonded sheet 100 for automobile door molding according to the present disclosure will be examined as follows.

FIG. 5 is a diagram illustrating a difference between a product made of the colored stainless steel bonded sheet for automobile door molding according to an embodiment of the present disclosure and a product made of the conventional 400 series stainless steel single sheet by bending each of the products, and FIG. 6 is a diagram illustrating a detailed state in which the colored stainless steel bonded sheet 100 for automobile door molding according to an embodiment of the present disclosure is deformed during forming or bending.

The drawings shown are photos of the colored stainless steel bonded sheet 100 for automobile door molding, in which a single sheet made of the 400 series stainless steel sheet and the bonded sheet according to the present disclosure are bent, respectively, and when the colored stainless steel bonded sheet 100 for automobile door molding is made of a single sheet, cracks occur on the surface when it is bent to a certain level or higher.

Specifically, FIG. 5A is a photo showing that a stainless steel for automobile door molding made of the 400 series stainless steel sheet is bent, and when deformation exceeding elongation occurs, cracks occur on the surface or damage occurs.

In this case, the 400 series stainless steel sheet exhibits magnetism and has a certain level or higher of hardness, so it is suitable as a material for positioning or maintaining a shape during processing, but there is a problem that processing is difficult due to low elongation for additional processing.

In addition, in the case of the automobile door molding that is usually made of only the 400 series stainless steel sheet, STS430J1L is mainly used. The 400 series stainless steel sheet is generally less expensive than the 300 series stainless steel sheet in terms of raw material cost. However, to be used for automobile door molding, the skin pass processes of controlling the surface gloss should be additionally performed 3 to 5 times, which leads to a significant increase in actual costs.

In contrast, as illustrated in FIG. 5B, when the colored stainless steel bonded sheet 100 for automobile door molding according to the present disclosure is made of the surface material 110 and the base material 120 formed of the bonded sheet, each material has its own characteristics.

In particular, when the base material 120 is bent inward, the surface material 110 may expand and maintain the surface condition without being damaged. Specifically, as illustrated in FIG. 6, the surface material 110 is bonded to the upper portion of the base material 120, but the base material 120 is formed relatively thick, so that the center line of the bonded sheet is positioned on the base material 120.

By the thickness difference between the surface material 110 and the base material 120, a distance d at which the surface material 110 is positioned from the center line is adjusted, and the surface material 110 is positioned at a position where a relatively large expansion occurs.

That is, the surface material 110 is positioned on the surface at a distance d from the center line of the bonded sheet, so that even when a relatively large expansion occurs, the surface material 110 may be deformed by high elongation and may maintain the surface condition.

In this way, the colored stainless steel bonded sheet 100 for automobile door molding according to the present disclosure is relatively easier to process than a single sheet made only of the 400 series stainless steel sheet, and may have excellent corrosion resistance due to the characteristics of the 300 series stainless steel sheet.

In particular, the colored stainless steel bonded sheet 100 for automobile door molding according to the present disclosure is processed into a desired shape through an additional process in a manufactured state.

The colored stainless steel bonded sheet 100 for automobile door molding according to the present disclosure is used in various types of products when manufacturing vehicle moldings, and a door belt method or a door frame method may be used.

This method is to roll-form the colored stainless steel bonded sheet 100 for automobile door molding and to bond a separate thermoplastic plastic (polyvinyl chloride (PVC)), thermo plastic elastomer (TPE), etc., through high-frequency induction heating, and then perform processes such as shearing, banding, and notching.

In addition, in contrast, a processing method through an insert injection method of Quarter Glass is used. This is a method of inserting a colored stainless steel bonded sheet 100 for automobile door molding processed by pressing into a mold and then injecting a thermoplastic plastic (PVC) to bond the colored stainless steel bonded sheet 100, and a magnet is embedded inside the mold to fix the position of the bonded sheet 100.

Therefore, in the case of manufacturing a vehicle molding through the above-described method, it is relatively easy to manufacture using a material having magnetism, but there is a problem that the processability of the 400 series stainless steel having magnetism is relatively lower than that of the 300 series stainless steel.

However, by manufacturing the bonded sheet 100 of the present disclosure by bonding the surface material 110 of the 300 series and the base material 120 of the 400 series, the metal finishing material has a certain level of magnetism and may fix the position through the magnet during additional processing.

In addition, when bending or press processing above a certain level is performed, the surface material 110 with relatively high elongation is positioned on the outside, so that cracks may be prevented from occurring on the surface.

That is, the present disclosure relates to the bonded sheet 100 in which the base material 120 made of the 400 series stainless steel sheet with magnetism and the surface material 110 made of the 300 series stainless steel sheet with non-magnetism are bonded, and when manufacturing the automobile door molding, it is possible to simply perform the molding processing process through the base material 120 having magnetism while preventing cracks from occurring on the surface through the large elongation characteristic of the surface material 110.

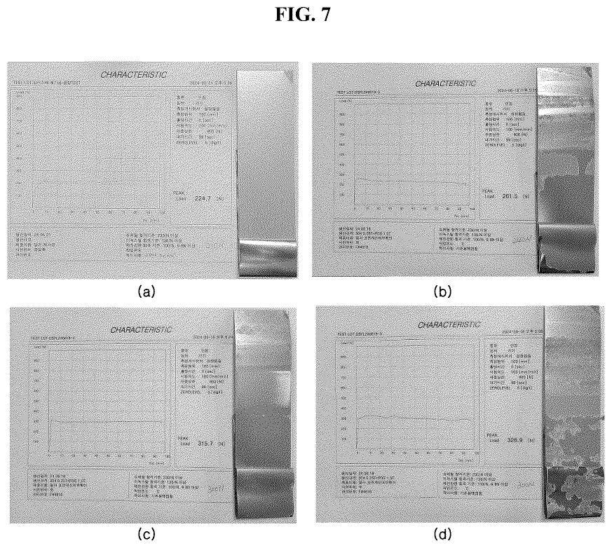

Next, referring to FIG. 7, it may be seen that the bonded sheet according to the present disclosure has an adhesive strength higher than a preset level.

FIG. 7 is a diagram illustrating the results of an adhesive strength test of the bonded sheet according to an embodiment of the present disclosure.

The bonded sheet 100 according to the present disclosure is configured to be bonded by including a separate adhesive layer 130 between the surface material 110 and the base material 120, but may have durability comparable to a single 400 series stainless steel sheet by maintaining the bonding strength higher than a certain level.

Specifically, referring to the drawing illustrated in FIG. 7, it may be confirmed that the peak load value of the measured value exceeds 200 [N] as a result of the bonding strength test (peel test) of the bonded sheet of the present disclosure.

This means that, even if the base material 120 and the surface material 110 of the present disclosure are formed in the form of the bonded sheet 100 bonded by the adhesive layer 130, the base material 120 and the surface material 110 have a strength similar to that of a single piece of actual material, and accordingly, it may be seen that there is no problem with the durability of the bonded sheet.

As described above, the bonded sheet according to the present disclosure has been examined, and this bonded sheet has excellent processability compared to the single sheet used in the past, and may stably maintain durability due to high elongation and tensile strength.

In addition, in the case of the sheet used for the automobile door molding, an additional gloss control process and a coloring process for controlling color may be performed, and in this process, the bonded sheet according to the present disclosure may be performed relatively cheaply and quickly compared to the 400 series stainless steel sheet used in the past.

First, referring to the gloss control process as a standard, in the case of the 400 series stainless steel single sheet used in the past, the skin pass process should be additionally performed based on STS430J1L to obtain the desired glossiness.

In particular, in the case of the 400 series stainless steel, although there is the skin pass process in the production process, the high-gloss surface may be obtained by performing an additional process 3 to 5 times.

In contrast, in the case of the bonded sheet 100 of the present disclosure, the surface material 110 itself is made of STS304, the 300 series thin sheet stainless steel, and thus may have gloss through a simple heat treatment process after rolling. Of course, an additional polishing process may be performed when desired, but a certain level or higher of glossiness may be generated through simple heat treatment alone.

That is, the bonded sheet 100 using the 300 series stainless steel as the surface material 110 and the 400 series stainless steel as the base material 120 as in the present disclosure may have a certain level or higher of gloss even without performing a separate polishing process.

Next, the difference between the bonded sheet 100 of the present disclosure and the existing 400 series single sheet with respect to the coloring process will be described.

In this case, the color is implemented by depositing titanium ions or chromium ions according to the color during the coloring process of the surface material 110, and the surface material 110 uses the 300 series stainless steel sheet.

For example, when the color of the surface material 110 is gold, the surface material 110 is deposited using nitrogen gas and titanium in a closed space, black uses carbon gas and chromium, and bronze color is implemented using a mixed gas of carbon and nitrogen and titanium.

In this way, the bonded sheet 100 for automobile door molding of the present disclosure may implement color through a separate coloring process on the surface material 110.

Generally, the coloring process is performed using a vacuum deposition method (physical vapor deposition (PVD)) in which a sheet is inserted into a closed space and deposited, or a nanoceramic coating (nano ceramic coating (NCC)) method.

First, when the coloring process is performed using the vacuum deposition method, the target is loaded into a vacuum chamber of a preset size, and coloring is performed through a deposition process after making it into a high vacuum state.

In this case, in the present disclosure, when loading the sheet into the vacuum chamber, it is wound in a coil shape, so that a relatively large amount of the sheet may be colored compared to the volume.

Here, in the present disclosure, instead of loading the entire bonded sheet, only the surface material 110 is wound and injected, so that a length of up to 2,500m (based on 0.15t) or more may be colored at once.

In contrast, in the case of the single sheet of the 400 series stainless steel, there is a problem in that it is difficult to wind and load due to the thickness of the sheet itself, and even when wound, the overall length itself is short, so that coloring may be performed only for a relatively short length compared to the method of coloring only the surface material 110 as in the present disclosure.

Specifically, when the coloring process through the vacuum deposition of the surface material 110 according to the present disclosure and the general 400 series stainless steel single sheet is performed once, the following results may be derived by comparing the production amounts, respectively.

First, looking at the penetration amount inside the vacuum chamber, in the case of the single sheet, it is formed with a thickness of 0.5t and may be penetrated up to a length of about 750m inside a limited vacuum chamber. In contrast, in the case of the surface material 110 according to the present disclosure, it is possible to penetrate up to a length of about 2500m under the same conditions with a thickness of 0.15t.

| | | Surface material |
|---|---|---|
| | | for bonded sheet |
| | Single sheet 0.5 T | 0.15 T |
| \textcircled{1} Penetration amount | 750M (2.5 ton) | 2,500M (2.5 ton) |
| \textcircled{2} Vacuum/Exhaust time | About 300 min | About 300 min |
| \textcircled{3} Coating time | 1.5M/min | 2.0M/min |
| | (about 500 min) | (about 1,250 min) |

Then, while the single sheet and the surface material 110 are each independently penetrated inside the vacuum chamber, the air inside is discharged for a preset time to create a vacuum state. In this case, the size of the vacuum chamber is the same, and accordingly, it takes about 300 minutes to create a vacuum state.

Thereafter, the deposition process is performed on each of the single sheet and the surface material 110 inside the vacuum chamber, and when the single sheet is inserted, it takes about 500 minutes to form a coating film of about 750m. When only the surface material 110 of the thin plate is inserted as in the present disclosure, it takes about 1,250 minutes to form a coating film of about 2,500 m.

In this case, the time required for coating after the vacuum atmosphere is formed in the vacuum chamber may be relatively short in the case of using the single sheet, but the length of the surface material 110 actually penetrated into the vacuum chamber is much longer, and a large amount may be coated at one time.

Accordingly, in the case of the single sheet, when a coloring coating is performed on a 750 m length through a vacuum deposition method, it takes 800 (300+500) minutes, and a length of about 0.94 m may be colored per minute, whereas in the case of the bonded sheet 100 of the present disclosure, when the coloring coating is performed on the surface material 110 through a vacuum deposition method, it takes 1,550 (300+1,250) minutes, and a length of about 1.6 m may be colored per minute.

In the vacuum deposition process, the exhaust time for achieving a vacuum inside the vacuum chamber is substantially the same, resulting in a difference in the length of material that may be colored within the same time period. Consequently, coloring only the surface material 110 allows for processing a greater length compared to coloring the single sheet.

That is, in the case of performing the coloring process by coating the surface using the above-described vacuum deposition method, unlike the conventional technique using the single sheet, the present disclosure allows only the relatively thin surface material 110 to enter the vacuum chamber. This enables a relatively larger quantity to be colored at once, thereby increasing the productivity of the bonded sheet 100 according to the present disclosure.

Meanwhile, when the coloring process is performed using the wet method, coloring the surface material 110 is relatively thinner in thickness than coloring the single sheet of the 400 series stainless steel, so energy consumption is reduced and the production speed increases accordingly.

Specifically, in the case of carrying out the coloring process in the wet method, drying is required after coating, and in the case of being made of the single sheet, the thickness is thick, so the drying time increases compared to the method of coating only the surface material 110 as in the present disclosure.

That is, in the case of the bonded sheet 100 in which the surface material 110 and the base material 120 are bonded as in the present disclosure, the coloring process may be carried out by performing surface treatment on the thin plate surface material 110 before bonding, and thus, the surface material 110, which is relatively thin compared to the existing single sheet, may be dried relatively quickly by coloring the surface material 110.

Therefore, the surface material 110 and the single sheet of the 400 series stainless steel, which are the coloring targets, basically have different thicknesses, and accordingly, a difference in productivity occurs in the coloring process.

In addition, since coating using a slot die is possible when only the surface material 110 is coated, it has a productivity of more than four times that of the currently used spray coating and may perform high-quality coating.

The geometric structure and physical properties of the colored stainless steel bonded sheet 100 for automobile door molding according to an embodiment of the present disclosure have been described above, and the process for manufacturing the bonded sheet 100 as described above will be described below.

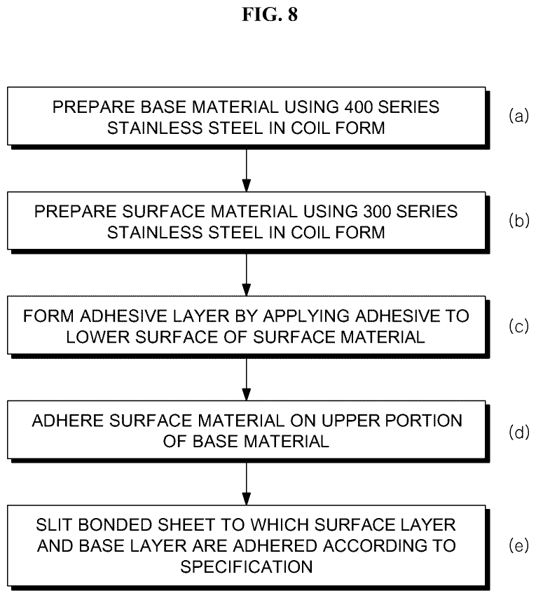

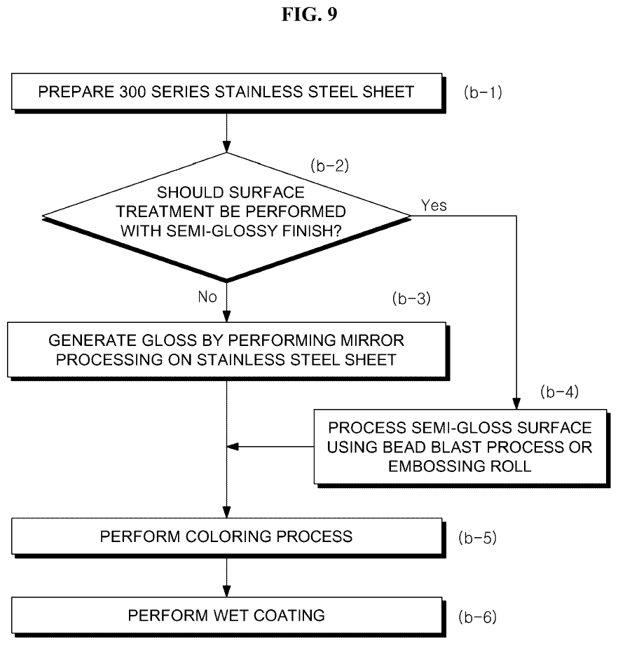

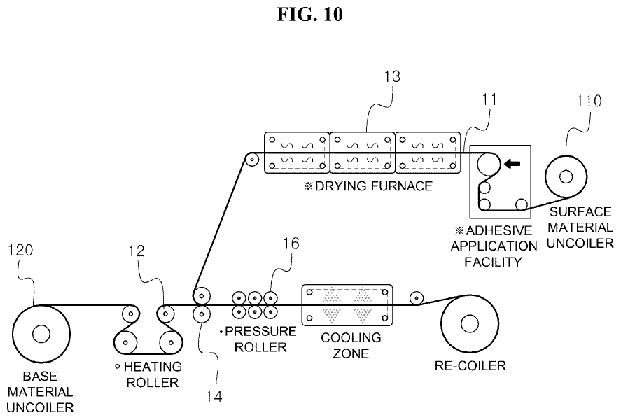

FIG. 8 is a diagram illustrating the entire manufacturing process of the colored stainless steel bonded sheet 100 for automobile door molding according to an embodiment of the present disclosure in sequence, FIG. 9 is a diagram illustrating a detailed process of manufacturing the surface material 110 in the manufacturing process of FIG. 8, and FIG. 10 is a diagram schematically illustrating a device for manufacturing a colored stainless steel bonded sheet 100 for automobile door molding of FIG. 9.

Looking at the overall manufacturing process of the colored stainless steel bonded sheet 100 for automobile door molding according to the present disclosure, first, step (a) of manufacturing the base material 120 using the 400 series stainless steel sheet, which is a ferrite series, is performed.

The base material 120 is manufactured in a flat shape with a preset thickness using the 400 series stainless steel sheet. Here, the base material 120 has a thickness of 0.3 mm to 0.7 mm and is manufactured in a form in which it is wound by a separate roller in an extruded state.

That is, as described above, the base material 120 is manufactured in a flat shape with a preset thickness and wound along the longitudinal direction.

As illustrated in FIG. 10, the base material 120 is wound and transported along a preset transport path by a separate heating roller 12. In this case, the heating roller 12 heats the base material 120 to a temperature above a certain level so that it may be stably bonded by the adhesive layer 130 when bonded to the surface material 110 later.

Next, step (b) of preparing the surface material 110 with the 300 series stainless steel sheet, which is austenite series, is performed.

The surface material 110 is made of a sheet having a certain thickness like the base material 120, but unlike the base material 120, it is made of the 300 series stainless steel sheet.

Specifically, the surface material 110 is formed to have a thickness of 0.1 mm to 0.3 mm, has an elongation of about 50%, and may be made of any one of the steel grades STS304, STS304L, STS304J1, STS316, or STS316L.

In this embodiment, the surface material 110 is manufactured in the form of a thin sheet like the base material 120, stored in a wound state, and then the wound portion is recoiled and transported so that it may be adhered to the base material 120.

Here, the surface material 110 may additionally undergo the coloring process to add color through a separate surface treatment before bonding with the base material 120.

Thereafter, a step (c) is performed to form an adhesive layer 130 to adhere the surface material 110 and the base material 120.

In the step (c), the adhesive layer 130 is formed between the surface material 110 and the base material 120 and is configured to be mutually bonded, so it is formed by being applied to at least one of the back surface of the surface material 110 or the upper surface of the base material 120.

In this embodiment, as illustrated in FIG. 10, it is applied to the lower surface of the surface material 110 and then dried to form the adhesive layer 130.

Here, the adhesive layer 130 is formed in a form of being applied to the lower surface through a separate application facility 11 provided on the transport path of the surface material 110, and is then transported and bonded to the base material 110. In this case, the surface material 110 may pass through a separate drying furnace 13 provided on the transport path, and may be transported while undergoing an additional drying process in which the adhesive layer 130 is applied.

In this way, after the step (c) of forming the adhesive layer 130 on the upper surface of the base material 120, the step (d) of bonding the base material 120 and the adhesive layer 130 is performed.

In the step (d), the adhesive layer 130 is positioned between the surface material 110 and the base material 120 and bonded to each other to manufacture the bonded sheet 100.

Specifically, in the step (d), as shown in FIG. 10, the base material 120 and the surface material 110 are mutually adhered and transported through a separate bonding roller 14 provided downstream of the heating roller 12 on the transport path.

In this case, the surface material 110 is transported independently from the base material 120, and is transported so as to be connected and joined on the transport path of the base material 120 at a downstream portion according to the transport direction.

In the present embodiment, the surface material 110 is independently transported after the adhesive layer 130 is formed on the lower surface, and is laminated on the upper portion of the base material 120.

That is, the surface material 110 and the base material 120 are each wound in a roll type as described above, and are transported by a plurality of rollers and a part of the transport path is integrated and laminated. The transport and bonding are simultaneously performed via the bonding roller 14 while the surface material 110 is laminated on an upper portion of the base material 120.

Here, the bonding roller 14 may be heated to a certain temperature, and the heating and pressurization may be performed simultaneously when bonding the base material 120 and the surface material 110.

In this way, the base material 120 and the surface material 110 are transferred to the bonded sheet 100 in a laminated state via the bonding roller 14 and pressurized via the pressure roller 16 and bonded to each other.

Thereafter, the base material 120 and the surface material 110 that passed through the pressure roller 16 are transferred in a completely bonded state via a separate cooling zone 18 and then recoiled and received again.

Next, step (e) of processing the bonded sheet to which the base material 120 and the surface material 110 are bonded into a preset shape is performed.

The step (e) is a process of slitting the bonded sheet according to the intended use, and slitting is performed according to the preset size and specifications.

The bonded sheet 100 according to the present disclosure is used for the automobile door molding, and may be cut to a shape and specifications appropriate for the size and used accordingly.

In particular, after the bonded sheet 100 according to the present disclosure is slit into the automobile door molding, various methods are used during the actual molding processing, and the door belt method, the door frame method, or the insert injection method of quarter glass may be used.

This method bonds the bonded sheet 100 with a separate thermoplastic plastic (polyvinyl chloride (PVC)) or thermo plastic elastomer (TPE) by a high-frequency induction heating method, and then performs processes such as shearing, bending, and notching, and also performs processes such as an insert injection method using a mold after press processing.

Therefore, when manufacturing a vehicle molding through the above method, even when the surface material 110 is deformed, the surface may be maintained in a stable state, and at the same time, the position may be stably fixed during molding processing through the magnetism characteristics of the base material 120.

By mutually bonding the surface material 110 having a preset area and the base material 120 attached to the back surface of the surface material 110, the colored stainless steel bonded sheet 100 for automobile door molding of the present disclosure manufactured through the above process may have the excellent durability, the elongation, and the tensile strength which are characteristics of the 300 series stainless steel, and may have magnetism, which is a characteristic of the 400 series stainless steel, and express characteristics such as relatively low production cost in a complex manner.

In addition, the step (b) according to the present disclosure may perform at least one of the gloss control process for controlling the gloss of the surface material 110 and the coloring process for controlling the color of the surface material 110.

Referring to FIG. 9, the gloss control process may control the glossiness by performing mirror processing on the surface through an additional process in advance during the processing of the surface material 110 or a process such as bead blasting, and in this embodiment, it is processed to have a glossiness of about 200 to 300 at an angle of 60°.

Specifically, the gloss control process for the surface material 110 is as follows.

First, a process (b-1) for preparing the 300 series stainless steel sheet is performed. A heat treatment process is performed on the stainless steel sheet. In this case, a selection process for selecting the gloss degree of the stainless steel sheet is performed (b-2).

In particular, it is necessary to select whether the gloss level of the surface material 110 will be processed with a standard glossy finish, a semi-glossy finish, or the glossiness itself will be adjusted to a certain degree, before proceeding with the subsequent processes.

Here, the surface material 100 may generally have a certain level or higher of glossiness with only simple heat treatment in the case of the 300 series stainless steel sheet, and when a high glossiness is required depending on the situation, a mirror process is performed (b-3).

That is, when the surface material 100 is manufactured with the glossy finish, heat treatment and an additional mirror process are performed.

In contrast, when the surface material 110 needs to be surface-treated with the semi-glossy finish, an additional bead blast process or a process using an embossing roll is additionally performed (b-4).

In this way, in the present disclosure, the surface material 110 undergoes the gloss control process before bonding with the base material 120, and may be adjusted to the glossy finish or the semi-glossy finish in the gloss control process.

For example, in the present disclosure, when the surface material 110 has the glossy finish, it has a thickness of 0.1 to 0.2t for STS304 or STS316, and a separate mirror processing process is performed on one surface. In addition, the base material 120 has a thickness of 0.3 to 0.6t for STS409, 411, 430, etc., and no separate surface treatment process is performed.

In addition, in the present disclosure, when the surface material 110 is to have the semi-gloss, the surface is treated through a pressurizing process using an additional embossing roll and a bead blasting process so that it has a desired gloss.

In this way, the surface material 110 in the present disclosure may undergo a gloss control process so that it has a desired level of gloss.

Thereafter, the gloss control process is performed, and the surface material 110 is manufactured to have the glossy finish or the semi-glossy finish, and a coloring process is performed (b-5).

Specifically, the coloring process is a process of coloring the surface material 110 using at least one inorganic material, and in the present disclosure, it is performed through the vacuum deposition using the physical vapor deposition (PVD) method and the wet coating method.

In this case, the color is implemented by depositing titanium ions or chromium ions according to the color during the coloring process of the surface material 110. In this case, the surface material 110 uses the 300 series stainless steel sheet.

Here, when the color of the surface material 110 is gold, the surface material 110 is deposited using nitrogen gas and titanium in a closed space, black uses carbon gas and chromium, and bronze color is implemented using a mixed gas of carbon and nitrogen and titanium.

Subsequently, the surface material 110 on which the coloring process has been performed may undergo additional nanoceramic wet coating (b-6).

By performing the nanoceramic wet coating, the surface of the surface material may be prevented from being contaminated, and it may greatly help in maintaining the durability and gloss of the surface.

In this way, the stainless steel bonded sheet 100 for automobile door molding of the present disclosure may implement color through a separate coloring process on the surface material 110.

As described above, the preferred embodiments according to the present disclosure have been reviewed, and the fact that the present disclosure can be embodied in other specific forms without departing from the spirit or scope in addition to the above-described embodiments is obvious to those skilled in the art. Therefore, the embodiments described above are to be regarded as illustrative rather than restrictive, and thus the present disclosure is not limited to the above description, but may be modified within the scope of the appended claims and their equivalents.

### DESCRIPTION OF SYMBOLS

100: Bonded sheet
110: Surface material
120: Base material
130: Adhesive layer
12: Heating roller
14: Bonding roller
16: Pressure roller

What is claimed is:

1. A colored stainless steel bonded sheet for automobile door molding, comprising:
a surface material made of a 300 series stainless steel sheet manufactured to a preset thickness;
a base material made of a 400 series stainless steel sheet that is attached to a back surface of the surface material in a flat shape and has magnetism; and
an adhesive layer positioned between the surface material and the base material to bond the surface material and the base material to each other,
wherein the surface material is formed by coating with a preset color through surface treatment, and
the surface material has a relatively greater elongation than the base material.

2. The colored stainless steel bonded sheet of claim 1, wherein the surface material is formed to have a thickness of 0.1 mm to 0.3 mm, and
the base material is formed to have a thickness of 0.3 mm to 0.7 mm.

3. The colored stainless steel bonded sheet of claim 1, wherein the surface material is made of one of the stainless steel grades STS304, STS304L, STS304J1, STS316, or STS316L, and
the base material is made of one of the stainless steel grades STS409, STS411, STS430, STS436, or STS441.

4. The colored stainless steel bonded sheet of claim 1, wherein the surface material expands when the base material is formed or bent toward inwardly, and maintains its surface condition without damage from cracking.

5. The colored stainless steel bonded sheet of claim 1, wherein the adhesive is applied to at least one surface of the base material or the surface material or is attached in a form of a film.

6. The colored stainless steel bonded sheet of claim 1, wherein the surface material has an elongation of approximately 50% or more and is made of a material that is relatively more resistant to processing shock than the base material.

7. The colored stainless steel bonded sheet of claim 1, wherein the surface material is wound in a roll type during the surface treatment process.

8. A manufacturing method of a stainless steel bonded sheet for automobile door molding, comprising the steps of:
(a) manufacturing a base material with a 400 series stainless steel sheet;
(b) preparing a surface material with a 300 series stainless steel sheet;
(c) forming an adhesive layer by applying an adhesive to either a back surface of the surface material or an upper surface of the base material;
(d) positioning the adhesive layer between the surface material and the base material and bonding the surface material and the base material to each other to manufacture the bonded sheet; and
(e) processing the bonded sheet into a preset size and shape,
wherein, in the step (b), a coloring process for controlling the color of the surface material is performed.

9. The manufacturing method of claim 8, wherein the bonded sheet bonded in the step (d) has a bonding force of 200N or more.

10. The manufacturing method of claim 8, wherein the surface material is performed by any one of a dry coating method using a vacuum deposition process, a wet coating method using wet coating on the surface, or a method of performing dry coating using vacuum deposition and then performing wet coating.
